(19) United States
(12) Patent Application Publication
(10) Pub. No.: US 2019/0392168 A1
(43) Pub. Date: Dec. 26, 2019

(54) SYSTEM AND METHOD FOR MONITORING FLOW OF DATA ELEMENTS OF ENTITIES

(71) Applicant: PRIFENDER INC., Bellevue, WA (US)

(72) Inventor: Nimrod LURIA, Bellevue, WA (US)

(21) Appl. No.: 16/016,622

(22) Filed: Jun. 24, 2018

(51) Int. Cl. G06F 21/62; G06F 17/30

(52) U.S. Cl. CPC G06F 21/6245; G06F 17/30339; G06F 17/30598; G06F 17/30297

(57) ABSTRACT

A system and method for monitoring flow of data elements of entities may include obtaining at least a first identifier of an entity. The identifier may be used to find data related to the entity in a set of data sources. A map of a distribution of data related to the entity across the set of data sources may be presented. An entity may be associate with at least one privacy obligation and a map may include an indication of a compliance of the data distribution with the privacy obligation.

### FIELD OF THE INVENTION

The present invention relates generally to data elements of an entity. More specifically, the present invention relates to identifying, tracking and mapping data elements of an entity in a plurality of data sources.

### BACKGROUND OF THE INVENTION

Systems and methods for protecting or securing data are known in the art. For example, a firewall may prevent access into a private or protected network, other systems use access permissions to restrict access to private data. However, known systems and methods do not enable identifying, tracking and mapping data elements of an entity, in a plurality of data sources, in a way that enables an organization to evaluate and enforce privacy and compliance with obligations. An entity as referred to herein may be a person or an organization. For example, data elements related to a person (that may be an employee of, or affiliated with, an organization) may be distributed across multiple data storage systems, possibly in different geographic locations, both in the organization and in other organizations. For example, electronic mail messages (emails) from an employee may be stored by a mail server in a first country, documents the employee drafted may be stored in a database located in a second country, personal data of the employee (e.g., phone number, home address) may be stored in a third system and so on. Moreover, some of the data related to the employee may be outdated, some of the data may be structured (e.g., in a table) and some may be unstructured (e.g., free text) and so on.

There currently exists no system or method that enables a global and/or complete view of a distribution of data elements of an entity. There currently exists no system or method that enables evaluating, verifying and/or enforcing of compliance with obligations, regulations or other aspects with respect to data elements of entities in an organization.

### SUMMARY OF THE INVENTION

In some embodiments, at least a first identifier of an entity may be obtained. The identifier may be used to find data related to the entity in a set of data sources. An embodiment may present a map of a distribution of data related to the entity across the set of data sources. An embodiment may associate the entity with at least one privacy obligation and may include, in the map, an indication of a compliance of the data distribution with the privacy obligation.

A privacy obligation may be related to at least one of: a privacy of the entity, an accountability of the entity, a privacy obligation of the organization and a regulation. An embodiment may generate an entity object that identifies the entity based on at least a first identifier and may increase an accuracy of the entity object by: a. using the at least first identifier to find at least a second identifier of the entity in the set of data sources; b. updating the entity object based on the first and second identifiers; and c. repeating steps a and b until the entity object identifies a single entity with a confidence level that is greater than a threshold.

Increasing the accuracy of an entity object may be based on at least one of: an identifier of the entity, metadata related to the entity and an obligation of the entity. An embodiment may update a first data source based on an identifier obtained from a second data source. An embodiment may identify, monitor and/or track a flow of data elements from a first data source to a second data source. An embodiment may identify an activity of an entity based on a distribution of data elements related to the entity. An embodiment may generate an alert if a distribution of data of an entity, across the set of data sources, does not adhere to a restriction. An embodiment may identify a set of entities affected by a breach of a restriction.

An embodiment may perform an action based on a distribution of data elements related to an entity. An embodiment may present a map that shows a distribution of data elements across at least one of: a data repository, a geographic location, an organization, an application and a sharing method. The set of data sources may be found by an automated scan, by an embodiment, of a network of an organization. An entity may be a person, an asset or a resource. An embodiment may associate a set of data elements in one or more storage systems with a respective set of categories; associate a set of relations between the data elements with a set of categorical schemas; and present a map of a distribution of data according to one of the categorical schemas. An embodiment may automatically define a categorical schema. A categorical schema may be related to at least one of: an identity, a privacy obligation, health, finance and a law.

An embodiment may automatically identify table structures in a structured database. An embodiment may automatically create a table structure based on unstructured data elements. An embodiment may automatically identify usage of shared information. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device according to illustrative embodiments of the present invention;

FIG. 2 shows a block diagram of a system according to illustrative embodiments of the present invention;

FIG. 3 is a screenshot of a screen according to illustrative embodiments of the present invention;

FIG. 4 illustrates updating an entity object according to illustrative embodiments of the present invention; and

FIG. 5 shows a flowchart of a method according to illustrative embodiments of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

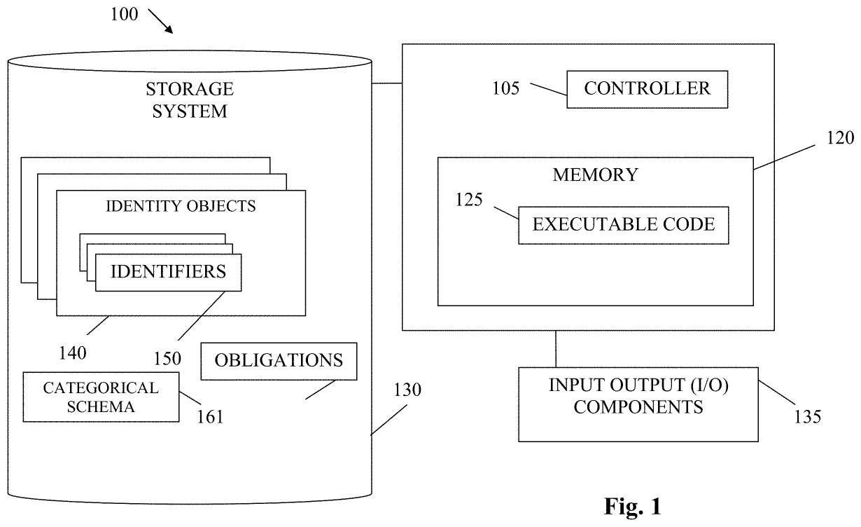

Reference is made to FIG. 1, showing a high-level block diagram of a computing device according to some embodiments of the present invention. Computing device 100 may include a controller 105 that may a hardware controller or processor. For example, controller 105 may be, or may include, a central processing unit processor (CPU), a chip or any suitable computing or computational device, a memory 120, executable code 125, a storage system 130, and input/output (I/O) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing device 100 may be included in, and one or more computing devices 100 may be, or act as the components of, a system according to some embodiments of the invention.

In some embodiments, by executing executable code 125 stored in memory 120, controller 105 may be caused or configured to carry out a method of associating data elements with identities in an organization, a method of mapping and presenting data elements according to geographic locations, organizations, privacy, obligations and so on as further described herein.

An operating system included in device 100 may perform tasks involving coordination, scheduling, arbitration, supervising, controlling or otherwise managing operation of computing device 100, for example, scheduling execution of software programs or enabling software programs or other modules or units to communicate. Accordingly, any number of units or modules may operate and collaborate in computing device 100. It will be noted that an operating system may be an optional component, e.g., in some embodiments, a system may include a computing device that does not require or include an operating system, for example, a microcontroller, an application specific circuit (ASIC), a field programmable array (FPGA) and/or system on a chip (SOC) that may operate without an operating system.

Memory 120 may be a hardware memory. For example, memory 120 may be, or may include, a Random-Access Memory (RAM), a read only memory (ROM), a Dynamic RAM (DRAM), a Synchronous DRAM (SD-RAM), a double data rate (DDR) memory chip, a Flash memory or other suitable memory units or storage units. In some embodiments, memory 120 is a computer or processor non-transitory readable medium, or a computer non-transitory storage medium, e.g., a RAM. Some embodiments may include a non-transitory storage medium 120 having stored thereon instructions which when executed cause processor 105 to carry out methods disclosed herein.

Executable code 125 may be an application, a program, a process, task or script. Executable code 125 may be executed by controller 105, possibly under control of an operating system as known in the art. For example, executable code 125 may be an application that associates data elements with identities and evaluates or verifies compliance with obligations as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described below (e.g., EM 210) may be, may each include or may share, controller 105, memory 120 and executable code 125.

As shown, storage system 130 may include or store a plurality of entity objects 140 that may each include identifiers 150. Entity objects 140 may be collectively referred to herein as entity objects 140 or individually as an entity object 140, identifiers 150 may be collectively referred to herein as identifiers 150 or individually as an identifier 150. Entity objects 140 and identifiers 150 may be any suitable objects or constructs, e.g., a table, a file, a memory segment or any other object that can include digital information. For example, an entity object 140 may be a table in a file where each row in the table is an identifier 150. As further shown, storage system 130 may include or store a plurality of obligations 160 and a plurality of categorical schema 161.

Obligations 160 and categorical schema 161 may be any suitable digital data structure or construct or computer data objects that enables storing, retrieving and modifying values. For example, obligations 160 and categorical schema 161 may be files, tables or lists in a database in storage system 130 and may include a number of fields that can be set or cleared, a plurality of parameters for which values can be set, a plurality of entries that may be modified and so on. For example, identifiers, obligations, relations and/or other values or parameters in an obligation or a categorical schema may be set, cleared or modified in obligations 160 and/or categorical schema 161, e.g., when defining, modifying or updating an obligation or categorical schema as described herein.

Storage system 130 may be or may include, for example, a hard disk drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, storage system 130 may be embedded or included in memory 120.

Input out (I/O) components 135 may be, or may include ports for connecting, a mouse, a keyboard, a touch screen or pad or any suitable input device. I/O components may include one or more displays or monitors, speakers and/or any other suitable output devices. Any applicable I/O components may be connected to computing device 100 as shown by I/O components 135, for example, a wired or wireless network interface card (NIC), a printer, a universal serial bus (USB) device or external hard drive may be included in I/O components 135.

In some embodiments, a system may include or may be, for example, a server computer, a network device, or any other suitable computing device. A system as described herein may include one or more devices such as computing device 100.

An embodiment may use artificial intelligence to map data elements containing personal information across networks (structured and/or unstructured). Although for the sake of clarity and simplicity, entities discussed herein are mainly humans (e.g., customers, employees) it will be understood that other entities may be applicable, e.g., an entity may be a person, a corporation, an asset and/or a resource. For example, an entity may a person, an asset and a resource be a company and identifiers of such entity may be addresses of branches, names of products manufactured or provided by the company and so on. In other cases, an entity may be a resource, e.g., a device and identifiers of the device may be a serial or model number and the like.

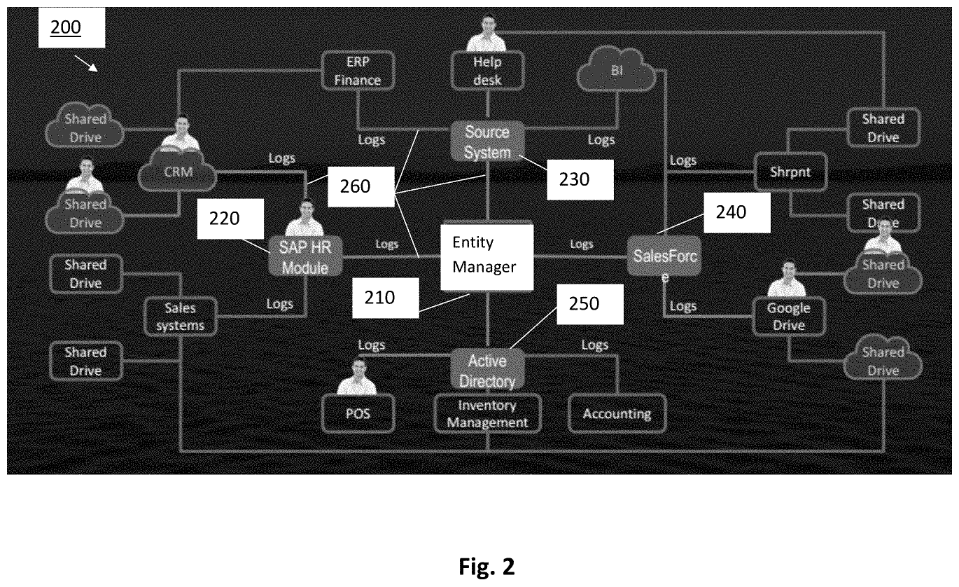

Reference is made to FIG. 2, an overview of a system 200 and flows according to some embodiments of the present invention. System 200 or components of system 200 may include components such as those shown in FIG. 1, for example, entity manager (EM) 210 may include one or more computing devices 100.

As illustrated in FIG. 2, data elements of (or related to) an entity (e.g., customer) may be distributed across multiple systems in an organization, e.g., some data elements may be stored in a human resource (HR) system 220, some may be stored in a salesforce system 240, some may be stored in an Active Directory (AD) system 250 and some may be stored in a source system 230 that may be any system that stores data. Systems and nodes shown in FIG. 2 may be connected to network 260 as shown by the lines connecting blocks in FIG. 2.

Network 260 may be, may comprise or may be part of, a private or public IP network, or the internet, or a combination thereof. Additionally, or alternatively, network 260 may be, may comprise or may be part of a global system for mobile communications (GSM) network. For example, network 260 may include or comprise an IP network such as the internet, a GSM related network and any equipment for bridging or otherwise connecting such networks as known in the art. In addition, network 260 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 260 are implied but not shown, e.g., access points, base stations, communication satellites, GPS satellites, routers, telephone switches, etc. It will be recognized that embodiments of the invention are not limited by the nature of network 260.

EM 210 may discover and associate data elements with identities in an organization. For example, EM 210 may receive or obtain at least a first identifier of a person (entity), e.g., EM 210 may receive as input a name of a person (e.g., John Smith, first identifier) or EM 210 may retrieve the name from a table of employees or customers in source system 230. EM 210 may then use the first identifier (e.g., John Smith) to discover or find identifiers or data related to the person in a set of data sources. For example, EM 210 may search systems 220, 250 and 240 for data elements that include, or that are associated with, John Smith. Discovered identifiers or data elements may be associated with an entity. For example, a phone number of John Smith discovered by EM 210 may be added, by EM 210, to an entity object 140 of John Smith.

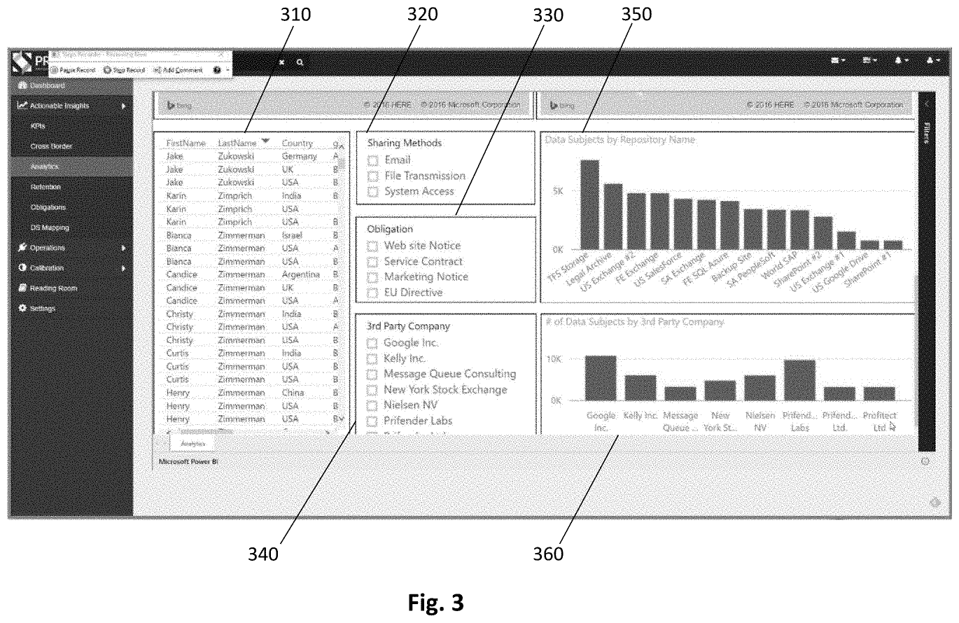

An embodiment may present (e.g., graphically as shown in FIG. 3) a distribution of data elements across, or with respect to, a plurality of data repositories, a plurality of geographic locations, a plurality of organizations, a plurality of applications and a plurality of sharing methods. Generally, an embodiment may find, determine, deduce and record (e.g., in an identity object 140), for each data element related to an entity, any metadata related to data elements of the entity. For example, EM 210 may record on what repository or storage system a data element was found, in what table, construct or object the data element was found, the geographic location of the data storage storing the data element, the type of data element (e.g., an email message, a file, a record, row or entry in a table or list), the relevant application (e.g., Outlook may be the relevant application for mail (.msg) data elements) and a sharing method used for communicating the data element (e.g., email may be the relevant sharing method for mail (.msg) data elements, cloud based storage may be the relevant sharing of files), the 3^{rd} party companies with which the data element is shared and so on. Accordingly, a distribution of data elements according to all of these aspects may be identified, recorded and presented, by embodiments, as described herein.

In some embodiments, a set of data sources are found by an automated scan of a network. For example, EM 210 may automatically and autonomously find or identify storage systems, devices, services and/or assets on a network of an organization.

For example, EM 210 may include, or may use, a sniffing unit adapted to capture packets or messages network 260 and thus identify storage systems, devices, services and/or assets connected to network 260. For example, as known in the art, some systems, assets or services broadcast or otherwise advertise services they provide by sending (broadcasting) network packets that provide information related to the type of service provided and/or information required in order to use the services (e.g., port number, IP address etc.). EM 210 may capture such packets and thus automatically identify storage systems or other assets or services on network 260.

In some embodiments, tables or other structured data objects are automatically identified. For example, EM 210 may be configured to automatically identify tables in databases based on their structure and/or based on content in the tables. For example, EM 210 may identify a table as related to demographics based on identifying fields containing age, gender and the like in the table. EM 210 may further identify the structure of the table, e.g., first name appears in the column, last name in the second column, age in the third column and so on. After identifying and recording structure of a table or other data objects, EM 210 may quickly find and identify identifiers or data elements in the table.

EM 210 may automatically identify tables and their structures based on metadata related to tables, e.g., a name and type of a table, type of information in a table and so on. For example, based on analyzing information in, or related to, a table in a database, EM 210 may determine whether the table is related to finance, demographics or healthcare.

In some embodiments, EM 210 may automatically create a table or other structured data object based on unstructured data elements. For example, EM 210 may identify, in any type of free text elements (e.g., posts in a social network, emails, text documents and the like), information such as names, addresses and phone numbers and may arrange or include such information in a table. Tables identified and/or created as described may be used for presentation to a user, e.g., a list of employees or customers presented to a user (e.g., as shown by block 310 in FIG. 3) may be based on identified or created tables as described.

In some embodiments, different fields in same or different tables or other structured data are linked, associated or mapped to the same category, type or attribute. For example, EM 210 may find a home address of an entity in a first field of a first table in a first database and may also find a home address of an entity in a second, different field of a second table in a second or same database. By associating, linking or mapping different fields across different systems, EM 210 may be able to find, identify and associate data elements or identifiers of same type with an entity even of these data elements or identifiers are included in dissimilar or different fields across different systems. It is noted that mapping, linking or associating different fields may be across different fields within a single system and/or across different fields in different systems. For example, different fields in one or more tables in system 220 may be linked, mapped or associated and different fields in one or more tables in systems 220 and 230 may be linked, mapped or associated.

Reference is made to FIG. 3, a screenshot of a screen that may be presented to a user. As shown by block 310, a list of entities (e.g., employees or customers of a company) may be presented and a user may select one of the employees or customers. As shown by block 320, a user may select to see the distribution of data elements according to one or more sharing methods, for example, a user may want to see data elements of a specific customer that were shared by emails, by file transmissions and so on. As shown by block 330, a user may filter a display of a distribution of data elements according to obligations.

Generally, an obligation can be any commitment taken by an organization with respect to data of an entity. For example, an obligation can be, or can include, committing not to disclose a name, an address and the like. In general, an obligation can be associated with any type of data, e.g., demographic data, information related to employment, health and so on. For example, a first obligation 160 (e.g., permitting sharing with specific organizations) may be associated with users' names (a first type of data element), a second obligation (e.g., forbidding sharing) 160 may be associated with phone numbers (a second type of data element) and so on. An obligation can include, specify or define actions that may be conditioned on rules. For example, an obligation can include a commitment to delete personal data, abide to specific regulations or contract, receiving consent before sharing or deleting information and so on.

In some embodiments, data elements are automatically associated with obligations. For example, EM 210 may associate an obligation, e.g., a rule that prevents sharing user's information, with data elements of a user. An embodiment may automatically identify a set of entities affected by a breach of a restriction, e.g., failure to fulfill an obligation.

Data elements of a user found on a plurality of systems as described may be checked against obligations and if a breach is found, a system may perform one or more actions, e.g., delete information that should not be shared according to an associated obligation. For example, assuming a first organization has an obligation not to share users' names and EM 210 finds that users names of the first organization were shared with a second organization (e.g., the names are found stored in a database of the second organization and the path from the first to the second organization is identified as described) then EM 210 may alert an administrator in the first organization.

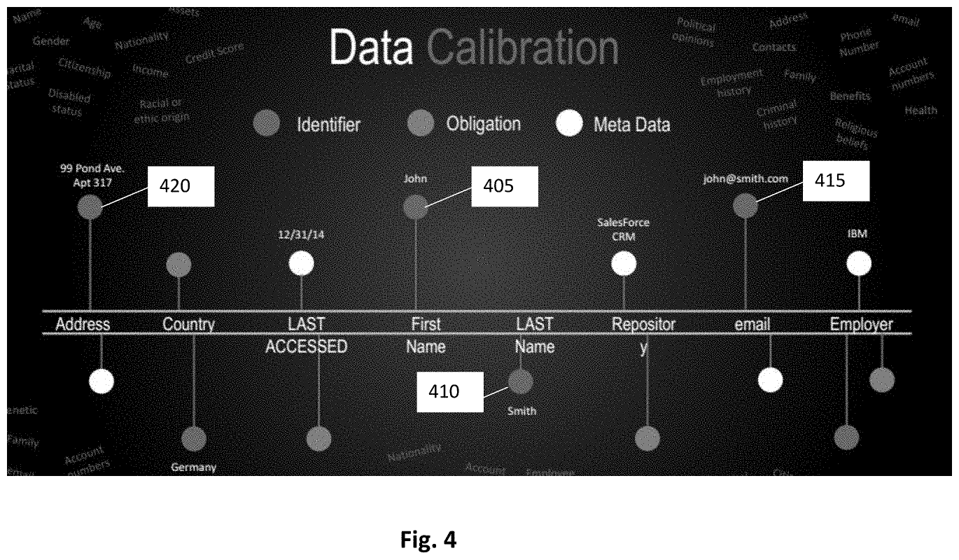

In some embodiments, obligations are checked with respect to data elements distributed across a plurality of systems and an embodiment may present to a user (e.g., in a map list or any other form) compliance and/or incompliance with obligations. For example, as shown in FIG. 4, an embodiment may show, to a user, which obligations are violated, e.g., which data elements of which users were shared although an obligation forbids the sharing.

In some embodiments, obligations 160 are created and updated based on data in source systems scanned as described herein. Generally, an obligation or privacy obligation 160 as referred to herein may be any suitable digital data structure or construct or computer data object that enables storing, retrieving and modifying values. For example, obligations 160 may be files, tables or lists in a database in storage system 130, and may include a number of fields that can be set or cleared, a plurality of parameters for which values can be set, a plurality of entries or strings that may be modified and so on. For example, a rule (e.g., share only with organization X) may be added to an obligation 160 and/or types of data elements or even unique identifiers of specific data elements for which the obligation 160 is to be effective. Accordingly, complex obligations 160 may be created and acted upon enabling embodiments of the invention to enforce obligations and/or monitor, track and identify whether or not obligations are kept or fulfilled. The terms “obligation” and “privacy obligation” as used herein mean the same thing and may be used herein interchangeably.

In some embodiments, obligations 160 are automatically created and/or updated. For example, if users' names are found in a list in a source system and the access to the list is restricted then EM 210 may automatically create an obligation 160 that restricts sharing the names and associate the obligation with data elements in the list. Any form or indication of an obligation in a source system may be used for automatically creating and/or updating obligations 160. In some embodiments, a user may indicate obligations and/or associate obligations with data elements, based on user input, obligations 160 may be created and associated with data elements. To some extent, applying an obligation to, or associating an obligation with, a data element, is somewhat similar to applying/associating a classification to/with a data element. Examples of data elements that may be associated with one or more obligations may be an address and a product or service, e.g., data related to a product secretly developed may be associated with an obligation designed to prevent sharing information related to the product.

Some embodiments detect and identify usage of data elements such as identifiers 150, identity objects 140 and/or other data as described. For example, by scanning or analyzing correspondence data such as emails, chatting logs of chat applications, text or multimedia content shared with a user, an embodiment can automatically identify or determine that usage of shared information (e.g., user name, user phone number etc.) was made, e.g., someone or some organization obtained a user name and email address and used these identifiers to correspond with the user.

Accordingly, embodiments of the invention can, if a breach of confidentiality has occurred, tell a user who was affected. For example, a post breach process can present to a user exactly information of which users was shared or leaked with/to external entities. Moreover, some embodiments of the invention automatically identify usage of shared information. For example, not only does an embodiment identify that an email of a user shared, but the embodiment further identifies the specific usage made with the shared information (e.g., advertisement material was sent to the user using the shared email). For example, and as described, by scanning or analyzing correspondence data such as emails an embodiment can automatically identify or determine the type or kind of usage made with or of shared information, e.g., someone obtained a user's email and used the email to send advertisement material, job offer and the like.

Moreover, by scanning or analyzing correspondence data such as emails, chatting logs of chat applications, text or multimedia content shared with a user, an embodiment can determine, identify and characterize the usage itself. For example, based on text analysis (e.g., contextual text analysis) EM 210 can identify the shared information was used for a political campaign, for a business campaign or other purposes. Accordingly, not only can embodiments of the invention identify how data such as identifiers 150 is shared and/or is distributed across many systems, embodiments of the invention can further identify and characterize the usage. The advantages of a system and method that can show to a user exactly how data of his organization (or data for which his organization has a responsibility and/or obligations) is shared with, or worse, leaked to, other systems or organizations will be readily appreciated by a person skilled in the art.

As shown by block 340, a user may filter a display of a distribution of data elements according to an entity, e.g., medical, academic or other institutes, 3rd party companies etc. For example, as shown by block 340, the user can choose to only see data that is shared by his organization with the NYSE and/or Google. Accordingly, unlike any known system or method, an embodiment can provide answers/responses to questions/requests like “what sensitive data am I sharing with Google?”, “what sensitive data am I sharing, via emails, with Kelly Inc.?”, “Who are the employees exposed (by sharing their information) to Nielsen NV?” and so on.

As shown by block 350, a presentation of data may include a distribution of data elements according to data repositories, e.g., the number of data elements related to a customer found in each of a set of data repositories. Any repository or storage system that stores or includes data elements may be identified. For example, a repository in block 350 may be a mobile device (identified as storing data elements as described).

As shown by block 360, a distribution of data elements according to 3rd party companies may be graphically presented.

EM 210 may generate an entity object (e.g., an entity object 140) that identifies an entity based on at least one (or first) identifier (e.g., an identifier 150) and may then increase the accuracy of the entity object by iteratively using a first identifier included in the entity object to find, in a set of data storage or source systems, a second identifier of the entity. For example, starting with the name John Smith, EM 210 may find John's email address (an identifier) in HR system 220 and may update John's entity object by adding the email address to John's entity object, use the email address to find John's home address in system 240, updating John's entity object by adding the home address and so on. EM 210 may keep (or repeat) updating an entity object until the entity object identifies a single entity with a confidence level that is greater than a threshold.

Reference is made to FIG. 4 which graphically illustrates updating an entity object (or data calibration) according to some embodiments of the present invention. For example, EM 210 may be provided with a first name “John” 405 (first identifier) as input or it may automatically identify first name 405, e.g., in HR system 220. EM 210 may then search a plurality of storage or source systems for identifiers related to John, find last name “Smith” 410 (second identifier) related to John and add this additional identifier to an entity object of John Smith. Next, EM 210 may search a plurality of data sources for identifiers of “John Smith”, find email address 415 (third identifier) and add the email address identifier to John's entity object.

Of course, EM 210 may find more than one John Smith in the plurality of storage or source systems searched. To uniquely and unambiguously identify a specific John Smith, EM 210 may iteratively search for additional identifiers related to John Smith and update an entity object for John Smith as described until the entity object uniquely and unambiguously identifies a single person. For example, although several persons named John Smith are found, only one of them may use the email address of john.smith.com and have the home address of 99 Pond Ave. Apt 317, accordingly, an entity object that includes identifiers “John”, “Smith”, “john.smith.com” and “99 Pond Ave. Apt 317” may uniquely and unambiguously identify one specific person.

Updating an entity object and/or increasing the accuracy of the entity object may be based on an identifier of the entity as described, metadata related to the entity and an obligation of the entity. EM 210 may associate an entity with one or more privacy obligations and may include, in a presentation to a user (e.g., a map, pie chart or other graphical elements), an indication of a compliance of data elements distribution with the privacy obligation. A privacy obligation may be related to at least one of: a privacy of the entity, an accountability of the entity, a privacy obligation of the organization and a regulation.

EM 210 may update a first data storage or data source based on an identifier obtained from a second data source or system. For example, referring to the above example, if both systems 220 and 250 include identifiers or data elements related to John Smith but the email address john.smith.com is found in system 250 but not in system 220 then EM 210 may update a table, record or other data (e.g., a list of customers and their details) in system 220 to include the email address. Accordingly, an embodiment may automatically synchronize information in a plurality of storage systems and maintain coherency and integrity of data related to an entity in a plurality of storage systems.

EM 210 may automatically identify, monitor and/or track a flow of the data (e.g., data elements as described herein) from a first data source or system to a second data source or system. For example, based on a modification time or data elements or identifiers of an entity, EM 210 may identify a chronological order or timeline according to which identifiers or data elements of an entity spread across a plurality of systems and thus identify, monitor and/or track (as well as present to a user as described) a flow of data across a network, e.g., EM 210 may determine that the phone number of John Smith was sent from system 220 to system 250. The flow of data elements may be graphically presented to a user enabling the user to see how (possibly sensitive) information is spread or distributed over a network and take actions to prevent unauthorized or undesired sharing of information. For example, it may be desirable for system 220 to include the home address of John Smith but may be considered noncompliance with a privacy obligation for system 230 to include such private information. Presented with a flow of data elements and identifiers such as a home address, a user can readily identify noncompliance of data distribution with a privacy obligation. EM 210 may be provided with a set of, restrictions or privacy compliance rules, may user the restrictions or rules to automatically identify noncompliance and may perform at least one action upon identifying noncompliance.

In some embodiments, EM 210 performs one or more actions based on a distribution of the data across systems or across a network. In some embodiments, EM 210 generates an alert if the distribution of data of an entity across a set of data sources or systems does not adhere to a restriction, compliance rule, regulation or any configuration parameter or value provided to EM 210. For example, an alert may be graphically presented, e.g., a red flag on a screen of computing device 100, or the alert may be a sound from a speaker connected to device 100. An alert may be automatically sent by EM 210, e.g., in the form of an email to a predefined list of recipients, an SMS message and the like. In some embodiments, EM 210 may be configured to enforce compliance or adherence to rules or obligations. For example, referring to the above home address, to maintain adherence and compliance as described, EM 210 may delete the home address from system 230.

In some embodiments, EM 210 identifies an activity of an entity based on the distribution of data related to the entity across a set of systems or networks. For example, by scanning or analyzing correspondence data such as emails, chatting logs of chat applications, text or multimedia content related to a user (sent or received by the user), an embodiment can determine, identify or characterize the type, nature or other aspects of an activity or state of the user, e.g., an embodiments determines or identifies that: the user is hospitalized; the user is actively participating in a political campaign; the user is actively searching for a new job, etc.

In some embodiments, EM 210 associates a set of data elements in one or more storage systems with a respective set of categories. For example, a set of data elements in a table identified as related to finance may be associated with a “Finance” category, another set of data elements may be associated with a “Healthcare” category and so on.

In some embodiments, EM 210 associates a set of relations between data elements with a set of categorical schemas 161 and presents a map of a distribution of data according to the set of categorical schemas 161. Generally, a categorical schema 161 includes definitions, classifications or categorizations a set of identifiers to be searched. Defining, classifying, grouping or referencing a set of identifiers by a categorical schema 161 can be based on, or according to, any schema, logic, rule or criteria. For example, a categorical schema 161 can group together a set of identifiers or other data elements based on relations between different elements (where the relations may be provided by a user or automatically defined). A categorical schema 161 may be related to one or more of: an identity, a privacy obligation, health, finance and a law.

For example, by identifying context of data elements found in different fields in a database and or found in different, separate systems, relations between different data elements are understood and mapped to a categorical schema 161 that may be an identity categorical schema, a categorical schema of privacy obligations, a categorical schema of health information and so on. For example, EM 210 may automatically discover the table structure within a structured database and thus determine the type, characteristics and nature of data elements in the structure. For example, EM 210 may determine that the first column in a table holds user names, the second column holds phone numbers and so on. Having characterized the fields in two or more tables or other structures according to a categorical schema 161, EM 210 may merge information in the two or more tables or structures and/or EM 210 can associate, group or categorize data elements in the two or more structures or systems, e.g., EM 210 may associate, group or categorize data elements in the two or more structures or systems with a categorical schema as described. For example, although names are in the first column of a first table found by EM 210 (e.g., in a first database, source system or organization) and are also in the third column of a second table found by EM 210 (e.g., in a second database, source system or organization) EM 210 may determine or identify that the first and third columns include the same type of data and merge the first and third columns, e.g., into a single list or table. In another example, EM 210 may associate, group or categorize data elements in the two or more structures or systems with a categorical schema such that a resulting list or table includes users' names, age, health score or condition and any other aspects. Accordingly, a complex categorical schema may be defined such that it relates to (or associates) a number of aspects or attributes of users or data elements and collecting, analyzing and/or presenting information may be according to a complex or other categorical schema may therefore relate to any number of aspects. For example, based on a schema, an embodiment may present information related to people who are older than forty, live outside the US and suffer from at least one chronic disease. A categorical schema may be related to one or more aspects such as, but not limited to, home or work address, age, gender, identity, demographic data, privacy obligation, health, finance and a law. An embodiment may search for data according to a categorical schema and/or an embodiment may filter, process and present information according to a categorical schema, accordingly, reports that provide extremely valuable, precise and specific information may be generated and presented as described. In addition, actions taken by embodiments may be triggered based on extremely precise and specific information, e.g., actions as described may be performed for users who are employed by a specific organization, live in a certain area, are all females and whose email addresses were shared, by a first specific organization with a second, specific organization.

In some embodiments, EM 210 automatically creates structured data (e.g., a table structure) from data it discovers in unstructured data storage systems or environments. For example, using artificial intelligence, EM 210 scans an unstructured environment and creates a table structure from data found by the scanning. In some embodiments EM 210 automatically defines and creates categorical schemas that can be used to help relate data elements in one system to another. For example, if EM 210 finds new, yet unknown data elements then EM 210 defines a new or additional categorical schema and associated the newly found data elements with the new categorical schema. Accordingly, an embodiment may automatically categorize data elements.

In some embodiments, EM 210 identifies relations between different elements and maps the relations to a categorical schema. A categorical schema to which data elements are mapped may be related to any aspect, e.g., an identity, a privacy obligation, health, finance, law or criminal history and so on. A categorical schema may be automatically defined. For example, if EM 210 finds a data element that cannot be mapped, or classified according, to a known or existing categorical schema, then EM 210 may define a new categorical schema and associate, link or map, the data element with/to the new categorical schema. EM 210 may link, or associate data element stored or included in two or more systems with a single or same categorical schema.

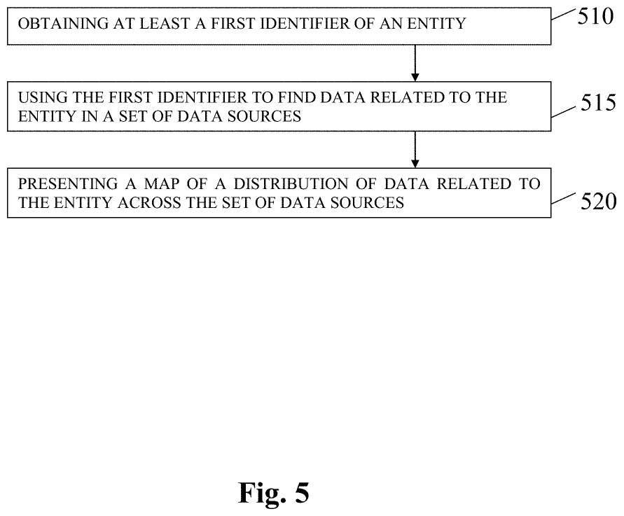

Reference is made to FIG. 5, a flowchart of a method according to illustrative embodiments of the present invention. As shown by block 510, an identifier of an entity may be obtained. For example, EM 210 obtains a name, address, title or address of an employee in an organization by scanning a database as described. As shown by block 515, the identifier may be used to find data related to the entity in a set of data sources. For example, using a name of an employee or customer, EM 210 searches for data related to employee or customer in source systems 230, 240 and 250 as described. As shown by block 520, a map of a distribution, across a plurality of systems, of data related to the entity may be presented. For example, distribution of data may be presented as shown in FIG. 3 and described herein.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of discovering and associating data elements with identities in an organization, the method comprising:
obtaining at least a first identifier of an entity;
using the first identifier to find data related to the entity in a set of data sources; and
presenting a map of a distribution of data related to the entity across the set of data sources.

2. The method of claim 1, comprising:
associating the entity with at least one privacy obligation; and
including, in the map, an indication of a compliance of the data distribution with the privacy obligation.

3. The method of claim 2, wherein the privacy obligation is related to at least one of: a privacy of the entity, an accountability of the entity, a privacy obligation of the organization and a regulation.

4. The method of claim 1, comprising:
generating an entity object that identifies the entity based on the at least first identifier and increasing an accuracy of the entity object by:
a. using the at least first identifier to find at least a second identifier of the entity in the set of data sources;
b. updating the entity object based on the first and second identifiers; and
c. repeating steps a and b until the entity object identifies a single entity with a confidence level that is greater than a threshold.

5. The method of claim 4, comprising increasing the accuracy of the entity object based on at least one of: an identifier of the entity, metadata related to the entity and an obligation of the entity.

6. The method of claim 4, comprising updating a first data source based on an identifier obtained from a second data source.

7. The method of claim 1, comprising identifying a flow of the data from a first data source to a second data source.

8. The method of claim 1, comprising identifying an activity of the entity based on the distribution of the data.

9. The method of claim 1, comprising generating an alert if the distribution of the data across the set of data sources does not adhere to a restriction.

10. The method of claim 9, comprising identifying a set of entities affected by a breach of the restriction.

11. The method of claim 1, comprising performing an action based on the distribution of the data.

12. The method of claim 1, wherein the map shows a distribution of the data across at least one of: a data repository, a geographic location, an organization, an application and a sharing method.

13. The method of claim 1, wherein the set of data sources are found by an automated scan of a network of the organization.

14. The method of claim 1, wherein the entity is one of: a person, an asset and a resource.

15. The method of claim 1, comprising:
associating a set of data elements in one or more storage systems with a respective set of categories;
associating a set of relations between the data elements with a set of categorical schemas; and
presenting the map of a distribution of data according to one of the categorical schemas.

16. The method of claim 15, wherein the categorical schemas are related to at least one of: an identity, a privacy obligation, health, finance and a law.

17. The method of claim 1, comprising at least one of:
automatically identifying table structures in a structured database, and
automatically creating a table structure based on unstructured data elements.

18. The method of claim 15, comprising automatically defining a categorical schema.

19. The method of claim 1, comprising automatically identifying usage of shared information.

20. A system comprising:
a memory; and
a controller configured to:
obtain at least a first identifier of an entity;
use the first identifier to find data related to the entity in a set of data sources; and
present a map of a distribution of data related to the entity across the set of data sources.
